(19) United States
(12) Patent Application Publication
(10) Pub. No.: US 2026/0322270 A1
(43) Pub. Date: Oct. 15, 2026

(54) USING PRIME NUMBERS FOR PHASE-FREQUENCY SPREADING IN POWER SUPPLY SWITCHING FREQUENCIES

(71) Applicant: Cisco Technology, Inc., San Jose, CA (US)

(72) Inventors: Joel Richard Goergen, Soulsbyville, CA (US); Kameron Rose Hurst, Sonora, CA (US)

(21) Appl. No.: 19/175,351

(22) Filed: Apr. 10, 2025

(51) Int. Cl. H02M 3/158; H02M 1/088

(52) U.S. Cl. CPC H02M 3/1584; H02M 1/088

(57) ABSTRACT

A controller of a multi-phase switch mode power supply system that controls a plurality of phases identifies a number of the plurality of phases. A timing schedule indicating when each phase, of the plurality of phases, is to be activated to deliver voltage to a load is determined based on the number of the plurality of phases and at least one prime number identified based on a phase number associated with each phase. Based on the timing schedule, each phase is activated to deliver the voltage to the load.

### TECHNICAL FIELD

The present disclosure relates to switch mode power supply units.

### BACKGROUND

Multi-phase switch mode power supply units are effective and widely used in many industries. In a multi-phase switch mode power supply unit, an input voltage is fed to a series of field effect transistors (FETs) that are controlled by Pulse Width Modulation (PWM) from a controller chip. In some cases, a differential mode ground frequency component may be created that interferes with operations of an application-specific integrated circuit (ASIC) being powered by the power supply unit.

### BRIEF DESCRIPTION OF THE DRAWINGS

FIG. 1 is a diagram illustrating an exemplary multi-phase switch mode power supply that may implement embodiments described herein.

FIG. 2 is a block diagram illustrating an exemplary printed circuit board including a PWM controller that may implement embodiments described herein.

FIG. 3 illustrates a prime number table that may be used when implementing the embodiments described herein.

FIG. 4A illustrates equations that may be used to determine a sum-based phase activation timing for phases controlled by a controller, according to an example embodiment.

FIG. 4B illustrates phase firing times for phases that are calculated using the equations illustrated in FIG. 4A, according to an example embodiment.

FIG. 5 illustrates equations that may be used to determine a series-based activation timing for phases controlled by a controller, according to an example embodiment.

FIG. 6 is a diagram illustrating a switch mode power system with multiple PWM controllers and multiple voltage rails, according to an example embodiment.

FIG. 7 is a block diagram illustrating a system in which a PWM controller has multiple parts that each controls multiple phases, according to an example embodiment.

FIG. 8 is a flow chart illustrating a method of spreading activation of phases of a multi-phase switch mode power supply system to deliver voltage to a load, according to an example embodiment.

### DETAILED DESCRIPTION

### Overview

In one embodiment, a method is provided. The method includes identifying, by a controller of a multi-phase switch mode power supply system that controls a plurality of phases, a number of the plurality of phases. A timing schedule indicating when each phase, of the plurality of phases, is to be activated to deliver voltage to a load is determined based on the number of the plurality of phases and at least one prime number identified based on a phase number associated with each phase. Based on the timing schedule, each phase is activated to deliver the voltage to the load.

In another embodiment, a multi-phase switch mode power supply system is provided. The multi-phase switch mode power supply system includes a plurality of circuits and a controller. Each circuit converts an input voltage to an output voltage. The controller is configured to identify a number of the plurality of circuits. The controller is further configured to determine, based on the number of the plurality of circuits and at least one prime number identified based on a phase number associated with each circuit, a timing schedule indicating when each circuit, of the plurality of circuits, is to be activated to deliver the output voltage to a load. Based on the timing schedule, the controller is configured to activate each circuit to deliver the voltage to the load.

In another embodiment, another multi-phase switch mode power supply system is provided that includes a first controller that controls a first plurality of phases and a second controller that controls a second plurality of phases. The first controller is configured to identify a first number of the first plurality of phases and determine, based on the first number of the first plurality of phases and at least one prime number identified based on a phase number associated with each phase of the first plurality of phases, a first timing schedule indicating when each phase, of the first plurality of phases, is to be activated to convert input voltage to a first output voltage. Based on the first timing schedule, the first controller is configured to activate each phase of the first plurality of phases to convert the input voltage to the first output voltage. The second controller is configured to identify a second number of the second plurality of phases and determine, based on the second number of the second plurality of phases and the at least one prime number identified based on a phase number associated with each phase of the second plurality of phases, a second timing schedule indicating when each phase, of the second plurality of phases, is to be activated to convert the input voltage to a second output voltage. Based on the second timing schedule, the second controller is configured to activate each phase of the second plurality of phases to convert the input voltage to the second output voltage.

### EXAMPLE EMBODIMENTS

Switch mode power supplies are effective power supply devices that are widely used across industries. A switched mode power supply converts power using switching devices that are turned on and off at high frequencies.

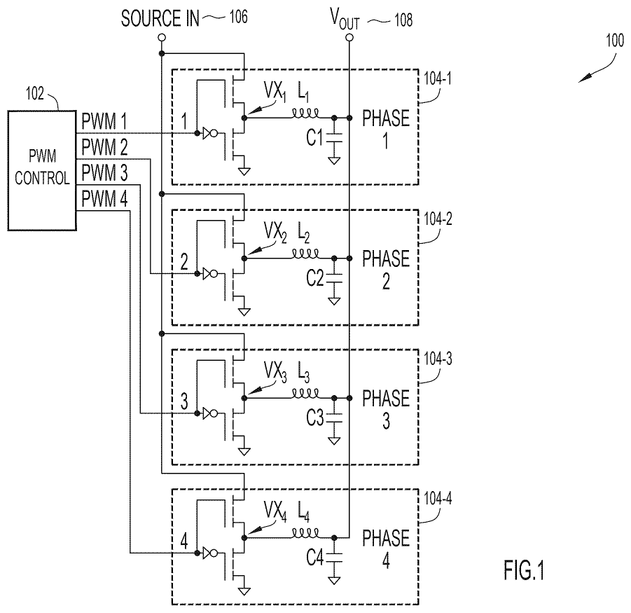

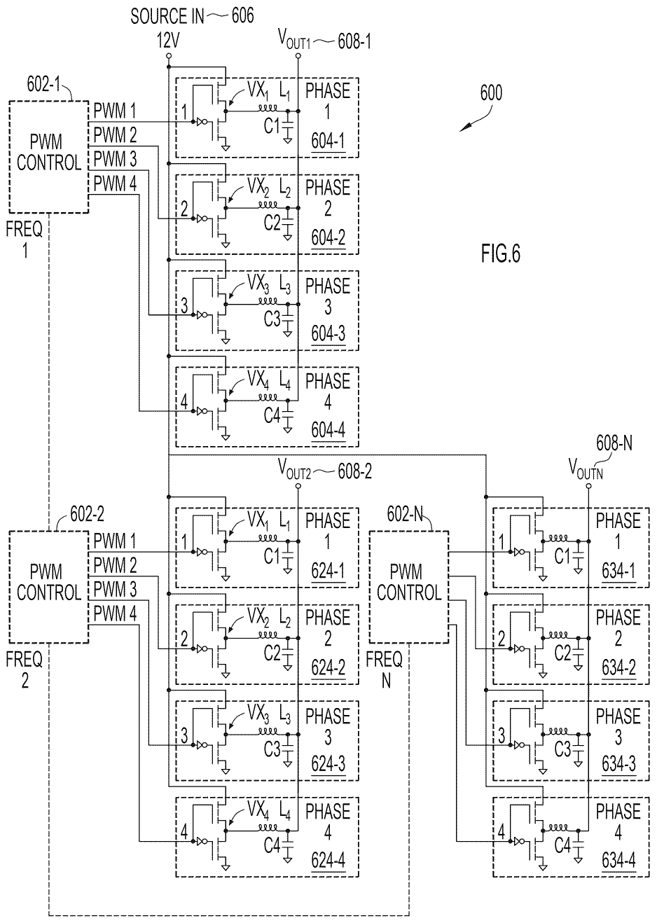

Reference is first made to FIG. 1. FIG. 1 is a block diagram of an exemplary multi-phase switch mode power supply 100 that includes four phases. Switch mode power supply 100 includes a pulse-width modulation (PWM) controller (control) 102 that controls four phases: phase 1 104-1, phase 2 104-2, phase 3 104-3, and phase 4 104-4. Switch mode power supply 100 receives input power from an input source (source in) 106 (e.g., 12 Volts) and converts the input voltage to an output voltage V_{OUT} 108 (e.g., 0.69V, 0.725V, 0.735V, 0.82V, etc.), such as for an Application Specific Integrated Circuit (ASIC) rail voltage. Although FIG. 1 illustrates a single PWM controller 102 on a printed circuit board, as described below with respect to FIG. 6, a printed circuit board may include multiple PWM controllers. In addition, although only four phases are illustrated in FIG. 1, PWM controller 102 may control more than four phases. The PWM controller 102 may be embodied by a microprocessor, microcontroller, digital signal processor or other processing device that may be configured with programmable instructions that, when executed, cause the PWM controller 102 to perform various operations described herein.

As illustrated in FIG. 1, each phase of the four phases uses a two field effect transistor (FET) switch circuit to convert the input voltage to the output voltage. The circuit of phase 1 104-1 is described herein, although the circuits of each of the phases include the same components. Only a portion of the circuit of phase 1 104-1 is described herein for simplicity and brevity. To convert the input voltage, a first FET, FET1, is turned on while a second FET, FET2, is turned off. When FET2 is turned off and FET1 is turned on, the circuit including inductor L1 and capacitor C1 is energized with voltage from source in 106 (e.g., 12 V). When phase 1 104-1 is to be activated to provide power to the ASIC rail, FET1 is switched off and FET2 is switched on. When FET1 is switched off and FET2 is switched on, the energy in inductor L1 is transmitted toward the ASIC rail output. The capacitor C1 is used to smooth out the peaks in the voltage.

Each phase includes a circuit that outputs voltage in the manner described with respect to phase 1 104-1. When four phases are put together, each phase is activated or “fired” to provide voltage to the output voltage rail. Each phase is activated at a different time or frequency to consistently provide the output voltage to the ASIC rail. For example, phase 1 104-1 may be activated at 0 degrees, phase 2 104-2 may be activated at 90 degrees, phase 3 104-3 may be activated at 180 degrees, and phase 4 104-4 may be activated at 270 degrees, of a switching waveform. In this way, each phase is activated in order so that every 90 degrees, the ASIC rail is energized with voltage.

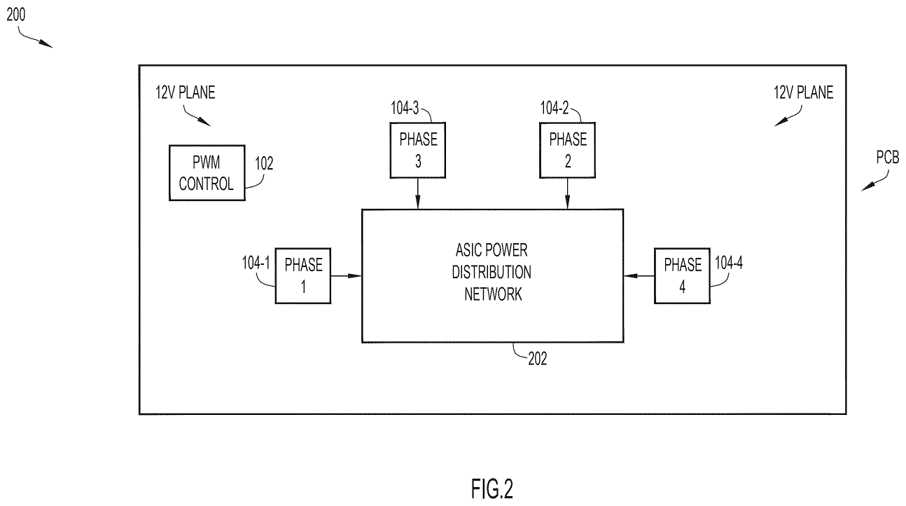

Reference is now made to FIG. 2. FIG. 2 is a block diagram illustrating a printed circuit board (PCB) 200 in which PWM controller 102 controls phases 104-1 to 104-2 to provide power to ASIC 202. In an example in which ASIC 202 receives 1000 amps (A) of current, each phase 104-1 to 104-4 drives approximately 250 A into ASIC 202. PWM controller 102 controls the order and timing of each phase. In this example, PWM controller 102 may activate phase 1 104-1 at 0 degrees, activate phase 2 104-2 at 90 degrees, activate phase 3 104-4 at 180 degrees, and activate phase 4 104-4 at 270 degrees. As illustrated in FIG. 2, circuits associated with successive phase numbers (e.g., that are activated successively) may be located on different sides of ASIC 202 or scattered around ASIC 202 (e.g., instead of next to one another) to avoid creating a current gradient that could lead to current and voltage issues for the ASIC 202.

As discussed above with respect to FIG. 1, when FET2 is switched off and FET1 is switched on, inductor L1 is charged with a voltage corresponding to source in 106 (e.g., 12V). When FET1 is switched off and FET2 is switched on, inductor L1 is discharged and the voltage in inductor L1 is transmitted to V_{OUT} 108. At the same time, because FET2 is connected to the ground plane, when FET2 is switched on, there is a current flow to the ground plane. Therefore, each time FET2 is switched on, there is a current flow and a ripple of voltage noise on the ground plane. In addition, since each circuit of each phase 104-1 to 104-4 is connected to the ground plane, each time a different phase is activated, there is a ripple of voltage noise on the ground plane.

In an example in which the ASIC voltage rail is 0.735V, the ripple of voltage on the ground plane may be approximately 0.075V, which is over 10% of the 0.735V signal. Ideally the voltage ripple should be under 1% of the signal. The high voltage noise signal on the ground plane can lead to an unintended fundamental frequency component that causes a problem for an ASIC being powered by the switch mode power supply unit.

The unintended frequency component that is created is equal to the number of phases in the switch mode power supply multiplied by the switch frequency in megahertz. A typical PWM system runs on a 500 kHz base. For the example illustrated in FIGS. 1 and 2, for a four-phase system running on a 500 kHz base, the unintended fundamental frequency component created is 2 MHz (4×0.5 MHz). For an eight-phase system, the fundamental frequency component is 4 MHz (8×0.5 MHz=4 MHz) and for an 11-phase system, the fundamental frequency component is 5.5 MHz (11×0.5 MHz=5.5 MHz). Any fundamental frequency component up to 100 MHz can create a problem for the ASIC 202.

Techniques described herein provide for decreasing the unintended fundamental components created by the PWM controller by using prime numbers to set the phase spreading between activation of different phases of the switch mode power supply. In addition, techniques described herein provide for using different prime numbers for the controller clock frequencies for different PWM controllers on a circuit board. Using prime numbers allows for the use of many controllers on a circuit board, each with a prime clock frequency and prime phase spacing in which any fundamental frequency component that is created is greater than 1 GHz with a very small decibel-milliwatts (dBm) magnitude.

According to a first embodiment, a phase firing/activation order is provided that does not create unintended frequency contributions under 200 MHz, thereby minimizing turn-off ringing that creates differential mode noise. As described above, by activating the different phases at equal intervals (e.g., 0 degrees, 90 degrees, 180 degrees, and 270 degrees for four phases), a large fundamental frequency component is created at the ground plane that creates problems for the ASIC receiving power from the switch mode power supply. However, by changing the activation times so that intervals between the activation of different phases are not exact, the fundamental frequency components created from the PWM controllers are dramatically lower.

Embodiments described herein provide for using an algorithm that incorporates prime numbers to determine when each phase of multiple phases is to be activated. In particular, a PWM controller may determine the number of phases being controlled by the controller and, using an algorithm or a set of equations, the controller may determine when to activate each phase based on the phase number associated with the phase. According to embodiments described herein, the phase spreading between activation of each phase using the algorithm or set of equations is approximately equal without being exactly equal. In this way, the phases are activated in a consistent manner without creating a fundamental frequency component in a range that causes problems for the ASIC.

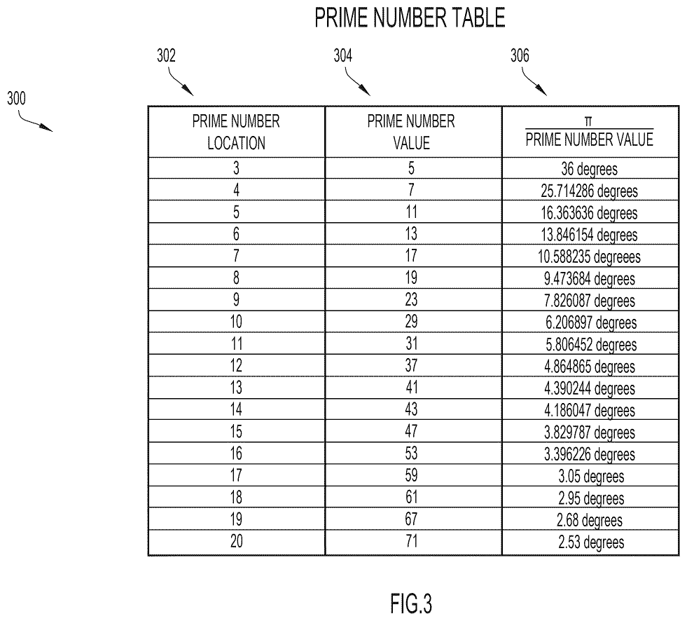

Reference is now made to FIG. 3. FIG. 3 illustrates a prime number table 300 that may be used when determining activation times or frequencies for different phases of a multi-phase switch mode power supply system. Prime number table 300 includes a prime number location column 302, a prime number value column 304, and a π/prime number value column 306. A lookup may be performed in prime number table 300 to determine values to be used when calculating the phase frequency for activating a phase.

The prime number values in the prime number value column 304 are the prime numbers that correspond to the prime number locations in the prime number location column 302. For example, in a list of the prime numbers (e.g., 2, 3, 5, 7, 11, 13, etc.), the third prime number (prime number location=3) is 5. As shown in prime number table 300, the prime number value of 5 corresponds to the prime number location 3.

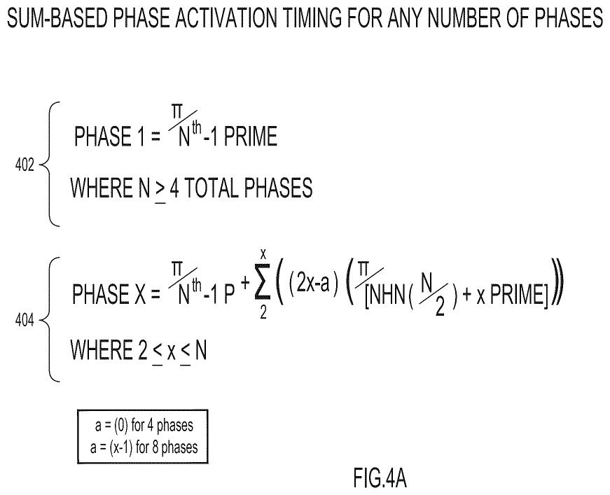

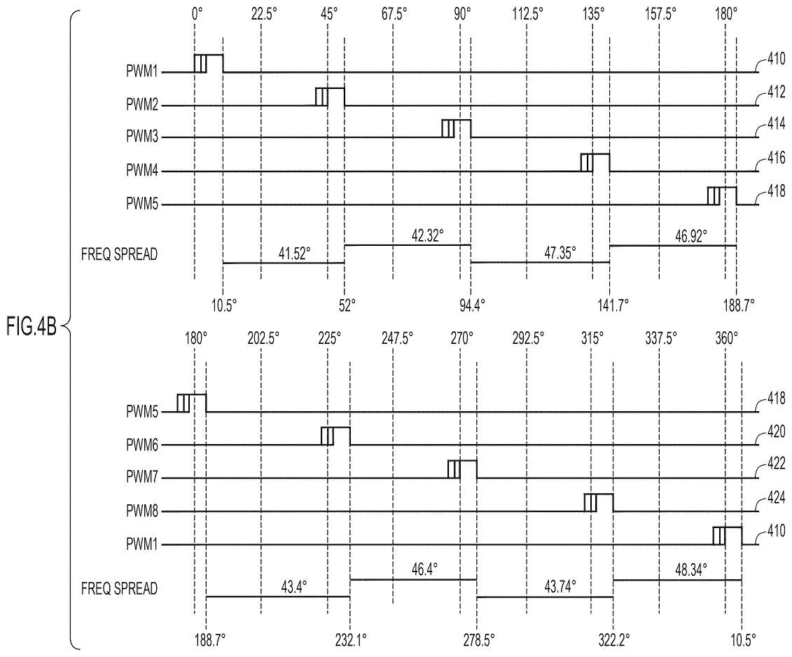

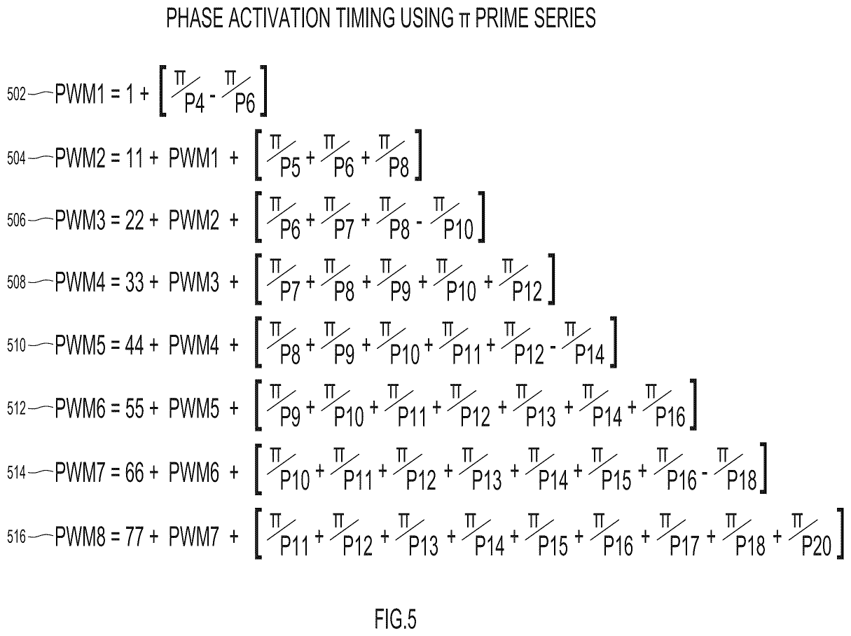

In the context of radians, π (pi) is equivalent to 180 degrees. Therefore, the π/prime number value column 306 indicates the value in degrees of 180 degrees divided by the prime number value. As an example, for the prime number location 7, the prime number value is 17 and π (or 180) divided by the prime number value of 17 is 10.588235 degrees. The values in the π/prime number value column 306 may be used in the equations described below with respect to FIGS. 4A and 5 when calculating the frequencies for different phases. For example, by performing a lookup in prime number table 300, it may be determined that π/prime 7 (i.e., the 7^{th} prime number) is the same is π/17 or 10.588235 degrees.

Reference is now made to FIG. 4A. FIG. 4A illustrates equations that may be used to determine a sum-based phase activation timing for any number of phases controlled by a controller. The algebraic geometric series equations shown in FIG. 4A may be used in one embodiment for determining the phase activation timing for the phases of a controller.

Equation 402 is an equation that may be used when calculating the phase activation timing for a first phase of a number of phases that is greater than or equal to 4. For example, if a controller controls four phases, equation 402 may be used to determine a timing (in degrees) for activating the first phase. In equation 402, N is the number of phases that the controller controls.

For example, for a four-phase system, N=4 and, therefore, the N^{th}−1 prime is the third prime value. Using prime number table 300, a lookup may be performed to determine that the prime number that corresponds to prime number location 3 is 5 and π/5 is 36 degrees. Therefore, using the sum-based phase activation timing, for a four-phase system, the first phase is activated at 36 degrees.

As another example, for an eight-phase system, N=8 and the N^{th}−1 prime is the seventh prime value. Using prime number table 300, a lookup may be performed to determine that the prime number that corresponds to 7 is 17 and π/17 is 10.59 degrees. Therefore, using the sum-based phase activation timing, for an eight-phase system, the first phase is activated at 10.59 degrees.

Equation 404 is a summation equation that may be used when calculating phase activation timing for the other phases (i.e., phases other than the first phase) being controlled by the controller. In equation 404, N is the number of phases being controlled by the controller, x is the number of the phase whose phase activation timing is being determined (i.e., for phase 2, x=2), a=0 when the number of phases (i.e., N) is 4, a=(x−1) when N=8, and NHN is the next whole number.

For example, for phase 2 of an eight-phase system, x=2, N=8, and a=(x−1). In this example, π/N^{th}−1 prime is π/17 or 10.58 degrees. NHN(N/2) is NHN (8/2) or 4. Therefore, phase 2=10.58 degrees +3(π/(4+2) prime)=10.58 degrees +3(π/6^{th} prime)=10.58 degrees +3(13.84)=52.10 degrees.

Reference is now made to FIG. 4B. FIG. 4B illustrates the phase firing times for 8 phases from 0 degrees to 180 degrees that are calculated using equations 402 and 404. In FIG. 4B, plot 410 illustrates the activation time of PWM phase 1, plot 412 illustrates the activation time of PWM phase 2, plot 414 illustrates the activation time of PWM phase 3, plot 416 illustrates the activation time of PWM phase 4, plot 418 illustrates the activation time of PWM phase 5, plot 420 illustrates the activation time of PWM phase 6, plot 422 illustrates the activation of PWM phase 7, and plot 424 illustrates the activation time of PWM phase 8.

Using the equations described in FIG. 4A, as shown in FIG. 4B, for an eight phase system, phase 1 is activated at 10.5 degrees, phase 2 is activated at 52 degrees, phase 3 is activated at 94.4 degrees, phase 4 is activated at 141.7 degrees, phase 5 is activated at 188.7 degrees, phase 6 is activated at 232.1 degrees, phase 7 is activated at 278.5 degrees, and phase 8 is activated at 322.2 degrees. Although FIG. 4B shows the activation times as corresponding to the falling edge of the activation of the phase, the activation time may correspond to the rising edge of the activation of the phase or another point in the activation of the phase. For example, some controllers may have a fixed front edge and the end edge may be modulated. In this example, the phasing may be between the rising edges of the waveform created by the activation of the phase.

As additionally illustrated in FIG. 4B, the phase spread between activation of phases is approximately equal, but is not exactly equal. For example, the frequency spread between the activation of phases 1 and 2 is 41.52 degrees, the frequency spread between the activation of phases 2 and 3 is 42.32 degrees, the frequency spread between the activation of phases 3 and 4 is 47.35 degrees, the frequency spread between the activation of phases 4 and 5 is 46.92 degrees, the frequency spread between the activation of phases 5 and 6 is 43.4 degrees, the frequency spread between the activation of phases 6 and 7 is 46.4 degrees, the frequency spread between the activation of phases 7 and 8 is 43.74 degrees, and the frequency spread between the activation of phases 8 and 1 is 48.34 degrees.

If the phases activate at frequency spreads that are of very different lengths, it is difficult for the capacitor and the inductor in the circuit to hold the regulation of the output voltage. In addition, if the activation of the different phases is out of balance, an inefficiency is introduced to the system. By activating the phases at relatively equal intervals, the ASIC rail is consistently receiving voltage from one of the eight phases and the output voltage is regulated. However, because the voltages are not at exact intervals, the activation order does not create unintended frequency contributors under 200 MHz, which reduces the differential mode ground noise.

In another embodiment, the timing of the activation of the different phases may be calculated in a different way. Reference is now made to FIG. 5. FIG. 5 illustrates a set of equations that may be used to calculate phase activation timing using a π prime series. The set of equations in FIG. 5 may be used as an alternative to the equations shown in FIG. 4A for determining a timing schedule for activating the different phases.

FIG. 5 illustrates eight equations, each of which may be used to calculate a frequency timing for activating a particular phase of the eight phases. The equations in FIG. 5 represent a geometric series for determining the timing for phase activation. Equation 502 may be used to calculate a timing for phase 1, equation 504 may be used to calculate a timing for phase 2, equation 506 may be used to calculate a timing for phase 3, equation 508 may be used to calculate a timing for phase 4, equation 510 may be used to calculate a timing for phase 5, equation 512 may be used to calculate a timing for phase 6, equation 514 may be used to calculate a timing for phase 7, and equation 516 may be used to calculate a timing for phase 8.

In the equations illustrated in FIG. 5, P #indicates the prime number values associated with the prime number location #. For example, P4 is the fourth prime number, which can be identified as 7 using the prime number table 300. In addition, the prime number table 300 may be used to determine the value of π/P #. For example, π/P4 is 25.71 degrees. Therefore, the timing for phase 1 (PWM 1) is equal to 1+[π/P4−π/P6]=1+[25.71 degrees−13.84 degrees]=12.87 degrees.

As shown by the equations in FIG. 5, each phase after the first phase incorporates the timing of the previous phase when calculating the timing for the phase. For example, equation 504, which is used to calculate the timing for phase 2 (PWM 2), incorporates the timing for phase 1 (PWM1) in the series sequence.

Using the equations illustrated in FIG. 5 provides a relatively even spreading between activation of phases without providing an equal spreading that leads to unintended fundamental components created by the PWM controller.

FIGS. 4A, 4B, and 5 illustrate exemplary equations using prime numbers that may be used to calculate the timing schedule for activating phases in a switch mode power system. In addition, other (different) equations may be used to calculate the timing schedule and minimize the unintended fundamental components.

Reference is now made to FIG. 6. FIG. 6 is a diagram illustrating a switch mode power system 600 with multiple PWM controllers and multiple voltage rails on a printed circuit board. Switch mode power system 600 includes PWM controller 602-1, PWM controller 602-2, and PWM controller 602-N. In some embodiments, PWM controllers 602-1, 602-2, and 602-N may be separate PWM controllers. In other embodiments, PWM controllers 602-1, 602-2, and 602-N may be a single PWM controller with N different parts, each part operating multiple phases (e.g., four phases), and each part using a different clock frequency.

In the example illustrated in FIG. 6, PWM controller 602-1 controls phases 604-1, 604-2, 604-3, and 604-4. PWM controller 602-2 controls phases 624-1, 624-2, 624-3, and 624-4. PWM controller 602-N controls phases 634-1, 634-2, 634-3, and 634-4. Although three PWM controllers are illustrated in FIG. 6, any number of PWM controllers may be on the printed circuit board. Each PWM controller 602-1 to 602-N receives source in 606. Each circuit controlled by a PWM controller outputs a voltage. As illustrated in FIG. 6, the circuit controlled by PWM controller 602-1 outputs V_{OUT1} 608-1, the circuit controlled by PWM controller 602-2 outputs V_{OUT2} 608-2, and the circuit controlled by PWM controller 602-N outputs V_{OUTN} 608-N. In one embodiment, the different circuits may output different voltages. For example, V_{OUT1} 608-1 may be 0.6V, V_{OUT2} 608-2 may be 0.75V, and V_{OUTN} 608-N may be 3.3V. However, each circuit receives the same input voltage (e.g., source in 606).

By selecting different switching frequencies for each of the PWM controllers 602-1 to 602-N, each PWM controller is able to use the same phase spreading algorithm without creating ground plane noise issues for the ASIC. According to embodiments described herein, the clock frequency of each controller may be set based on prime numbers. For example, to minimize the effects of the fundamental frequency, each PWM controller may operate using a different clock frequency. Each clock frequency may be determined based on a prime number around a common fundamental frequency among clock frequencies of the plurality of controllers. For example, each clock frequency may be determined based on a prime number around 500 kHz. For some power distribution networks, the optimal frequency for efficiency is close to 500 kHz, so selecting clock frequencies that are not close to 500 kHz can be problematic to additional power consumption in the circuit.

In many cases, a controller or set of controllers may be more efficient around a fundamental component (e.g., 500 kHz). In one embodiment, prime numbers around 500 kHz that are within the margin of error for an individual controller frequency may be selected as clock frequencies for different PWM controllers. In this embodiment, the clock frequencies may be prime numbers that are approximately 100 kHz apart. For example, for a system with 8 controllers, the prime numbered frequencies 500,107 kHz, 500,197 kHz, 500,299 kHz, 500,413 kHz, 500,509 kHz, 500,677 kHz, 500,791 kHz, and 500,891 kHz may be used as clock frequencies for the different controllers. These prime numbers are exemplary and different prime numbers may be selected as clock frequencies. Selecting the different clock frequencies based on prime numbers that are around a fundamental component and around 100 kHz apart reduces any fundamental frequency created across the multiple controllers.

In another embodiment, clock frequencies may be determined by selecting prime numbers around a common base (e.g., 500) and multiplying the prime numbers by 1000 Hz. In this embodiment, a different prime number near the common base may be selected for each controller. For example, for a system with 8 controllers, the different controllers may have clock frequencies of 521 kHz, 541 kHz, 557 kHz, 571 kHz, 599 kHz, 617 kHz, 647 kHz, and 659 kHz. These prime numbers are exemplary and different prime numbers may be selected as the base clock frequencies. Because prime numbers x 1 kHz are used as base frequencies for the controllers, the clock frequencies for the controllers cannot be the same or multiples of other clock frequencies.

In yet another embodiment, clock frequencies may be determined by selecting prime values from a table based on a prime number base. For example, if a prime number base of 461 is selected, prime numbers in the format 461,XXX kHz may be selected as clock frequencies for the controllers. In this example, for the system with 8 controllers, the different controllers may have clock frequencies of 461,059 kHz, 461,093 kHz, 461,101 kHz, 461,119 kHz, 461,143 kHz, 461,147 kHz, 461,171 kHz, and 461,183 kHz. Using prime values from the prime number tables as clock frequencies means there are not visible harmonics through 100 GHz ground plane noise.

By selecting different clock frequencies for the different controllers, each controller may use the same method for determining the activation schedule for different phases (e.g., using the equations in FIG. 4A, the equations in FIG. 5, or another method) without an unwanted fundamental frequency component. In other words, by spanning both frequency and phase firing at π/prime values and prime numbers, a true low level differential mode ground noise floor is created without the risk of fundamental frequency component building blocks. Returning to the example described above in which the ASIC voltage rail is 0.735V and the ripple of voltage on the ground plane is around 75 millivolts, by spreading the firing order of the phases and by spreading the controller frequencies using the techniques described herein, the noise on the ground plane can be reduced to 3.5-4 millivolts. Therefore, by using prime numbers to determine the activation times of the different phases and using prime numbers to determine the clock frequencies for different controllers, the noise on the ground plane can be dramatically reduced.

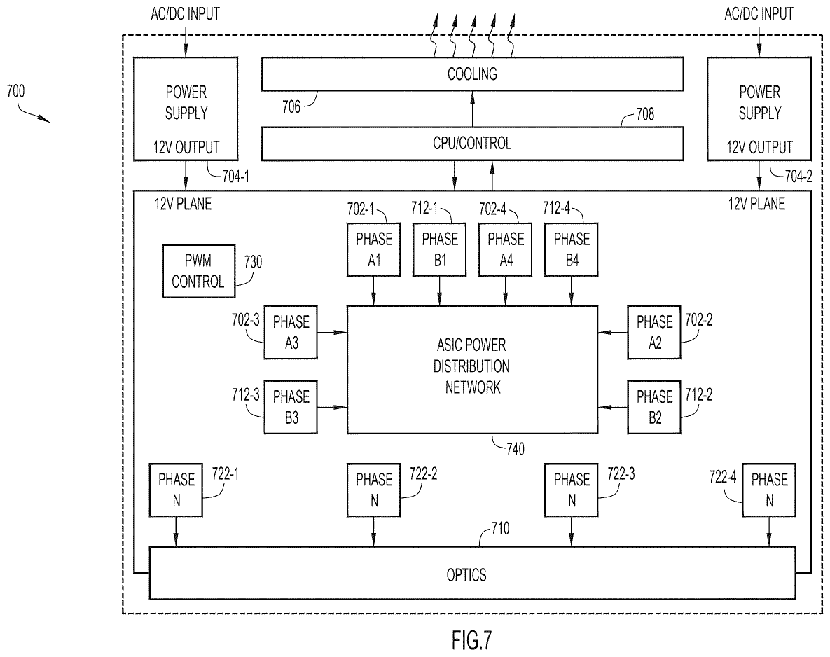

Reference is now made to FIG. 7. FIG. 7 is a block diagram illustrating a system 700 in which a PWM controller has multiple parts that each controls multiple phases. System 700 includes PWM controller 730 that provides power to ASIC 740 and optics 710, power supplies 704-1 and 704-2, a cooling module 706, and a central processing unit/controller 708.

Similar to the example illustrated in FIG. 6, PWM controller 730 has multiple parts (e.g., part A, part B, and part N) and each part controls multiple phases. For example, part A controls four phases (phase A1 702-1, phase A2 702-2, phase A3 702-3, and phase A4 702-4), part B controls four phases (phase B1 712-1, phase B2 712-2, phase B3 712-3, and phase B4 712-4), and part N controls four phases (phase N 722-1, phase N 722-2, phase N 722-3, and phase N 722-4). Each part of PWM controller 730 may have a different clock frequency. In one embodiment, each clock frequency may be a prime number around a fundamental component, such as 500 kHz. In other embodiments, each clock frequency may be a prime number base (e.g., near 500) multiplied by 1000 Hz or from a prime number table associated with the prime number base. In this way, by choosing different clock frequencies based on prime numbers, each part of PWM controller 730 will not multiply or beat with any other part of PWM controller 730 in a way that might create unintended contributors.

PWM controller 730 may receive a power supply (e.g., 12V) and convert the received power to a different output voltage. Each part of PWM controller 730 may output a different voltage. For example, part A may output 0.6V to ASIC 740, part B may output 0.75V to ASIC 740, and part N may output 3.3 V to optics 710. As illustrated in FIG. 7, a single PWM controller 730 is able to drive many different phases (e.g., 12 phases) and convert the input voltage (e.g., 12 V) to different nominal power values for the system. Because each part of PWM controller 730 is operating at a different clock frequency, each part of PWM controller 730 may use the same phase spreading algorithm for determining the timing of activation of the phases.

Although the techniques herein have been described with respect to converting an input voltage (e.g., 12 V) to an output voltage (e.g., 0.6 V, 0.75 V, 3.3 V, etc.) for providing to an ASIC or optics, the techniques described herein may be applied to other circuit components or loads. For example, the techniques described herein may be used to convert a higher voltage to the input voltage. For example, the techniques described herein may be used to convert a 54 V input to the voltage of 12 V. In a similar manner, the techniques described herein may be used to obtain the 54 V from, for example, a 239 V input.

In addition, the techniques described herein may be applied to other types of systems, such as fault managed power (FMP) systems. For example, if multiple transceivers in an FMP system are all phase aligned, a ground plane noise problem may occur. In this scenario, a PWM controller may be used to activate the pulsing of each transceiver and the techniques described herein may be applied by the PWM controller to determine the timing for activating the pulses for each transceiver.

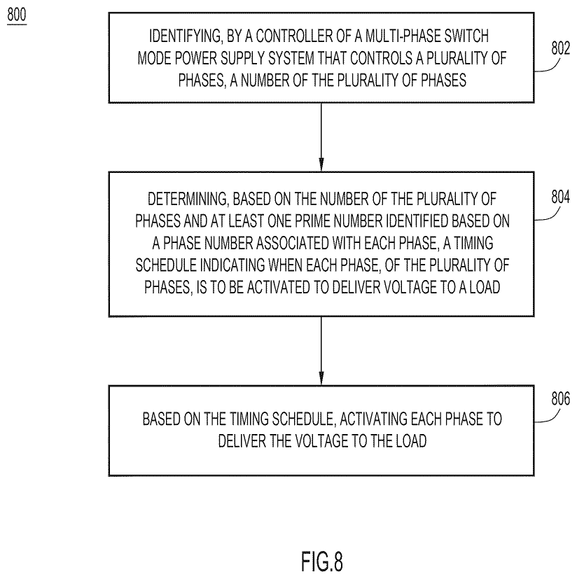

Reference is now made to FIG. 8. FIG. 8 is a flow chart illustrating a method 800 of spreading the activation of phases of a multi-phase switch mode power supply system to deliver voltage to a load. At 802, a controller of the multi-phase switch mode power supply system that controls a plurality of phases identifies a number of the plurality of phases. For example, the controller may identify how many phases the controller is controlling.

At 804, a timing schedule is determined indicating when each phase, of the plurality of phases, is to be activated to deliver voltage to a load. The timing schedule is determined based on the number of the plurality of phases and at least one prime number that is identified based on a phase number associated with each phase. For example, the timing schedule may be determined using an equation that incorporates one or more π/prime number values, such as the equations discussed with respect to FIGS. 4A and 5.

At 806, each phase is activated based on the timing schedule, to deliver the voltage to the load. Activating the phases based on the timing schedule decreases unintended fundamental frequency components created by the controller.

In summary, according to techniques described herein, differential mode ground noise for low side FET ringing is reduced by spreading the phase firing order of phases controlled by a controller and using prime number-based clock frequencies for different controllers to remove unintended fundamental frequency building blocks interfering with ASIC operation.

In one form, a method is provided that includes identifying, by a controller of a multi-phase switch mode power supply system that controls a plurality of phases, a number of the plurality of phases; determining, based on the number of the plurality of phases and at least one prime number identified based on a phase number associated with each phase, a timing schedule indicating when each phase, of the plurality of phases, is to be activated to deliver voltage to a load; and based on the timing schedule, activating each phase to deliver the voltage to the load.

In one form, determining the timing schedule includes determining when each phase is to be activated using the at least one prime number that is identified based on the phase number associated with each phase and a summation equation. In another form, determining the timing schedule includes determining when each phase is to be activated using a prime number series in which a time of activation of each phase after a first phase is calculated based on a previous time of activation of a previous phase. In another form, determining the timing schedule includes determining the timing schedule such that that a time between activation of each phase is approximately equal.

In another form, the multi-phase switch mode power supply system includes a plurality of controllers on a printed circuit board and each controller of the plurality of controllers has a different clock frequency that is based on a prime number near a common fundamental frequency among clock frequencies of the plurality of controllers. In another form, each different clock frequency is approximately 100 Hz apart from a clock frequency of another controller of the plurality of controllers. In another form, determining the timing schedule includes determining the timing schedule such that differential mode ground noise from low side field effect transistor (FET) ringing is minimized.

In another form, a multi-phase switch mode power supply system is provided that includes a plurality of circuits, each circuit converting an input voltage to an output voltage; and a controller configured to: identify a number of the plurality of circuits; determine, based on the number of the plurality of circuits and at least one prime number identified based on a phase number associated with each circuit, a timing schedule indicating when each circuit, of the plurality of circuits, is to be activated to deliver the output voltage to a load; and based on the timing schedule, activate each circuit to deliver the output voltage to the load.

In yet another form, a multi-phase switch mode power supply system is provided that includes a first controller that controls a first plurality of phases, wherein the first controller is configured to: identify a first number of the first plurality of phases, determine, based on the first number of the first plurality of phases and at least one prime number identified based on a phase number associated with each phase of the first plurality of phases, a first timing schedule indicating when each phase, of the first plurality of phases, is to be activated to convert input voltage to a first output voltage, and based on the first timing schedule, activate each phase of the first plurality of phases to convert the input voltage to the first output voltage; and a second controller that controls a second plurality of phases, wherein the second controller is configured to: identify a second number of the second plurality of phases, determine, based on the second number of the second plurality of phases and the at least one prime number identified based on a phase number associated with each phase of the second plurality of phases, a second timing schedule indicating when each phase, of the second plurality of phases, is to be activated to convert the input voltage to a second output voltage, and based on the second timing schedule, activate each phase of the second plurality of phases to convert the input voltage to the second output voltage.

In one example, the first controller and the second controller are parts of a single controller. In another example, the first controller and the second controller are located on a printed circuit board. In another example, the first controller has a first clock frequency and the second controller has a second clock frequency that is different from the first clock frequency. In another example, the first clock frequency and the second clock frequency are determined based on prime numbers. In another example, the first clock frequency and the second clock frequency are approximately 100 kHz apart.

### Variations and Implementations

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
identifying, by a controller of a multi-phase switch mode power supply system that controls a plurality of phases, a number of the plurality of phases;
determining, based on the number of the plurality of phases and at least one prime number identified based on a phase number associated with each phase, a timing schedule indicating when each phase, of the plurality of phases, is to be activated to deliver voltage to a load; and
based on the timing schedule, activating each phase to deliver the voltage to the load.

2. The method of claim 1, wherein determining the timing schedule includes determining when each phase is to be activated using the at least one prime number that is identified based on the phase number associated with each phase and a summation equation.

3. The method of claim 1, wherein determining the timing schedule includes determining when each phase is to be activated using a prime number series in which a time of activation of each phase after a first phase is calculated based on a previous time of activation of a previous phase.

4. The method of claim 1, wherein determining the timing schedule includes determining the timing schedule such that that a time between activation of each phase is approximately equal.

5. The method of claim 1, wherein the multi-phase switch mode power supply system includes a plurality of controllers on a printed circuit board and each controller of the plurality of controllers has a different clock frequency that is based on a prime number near a common fundamental frequency among clock frequencies of the plurality of controllers.

6. The method of claim 5, wherein each different clock frequency is approximately 100 Hz apart from a clock frequency of another controller of the plurality of controllers.

7. The method of claim 1, wherein determining the timing schedule includes determining the timing schedule such that differential mode ground noise from low side field effect transistor (FET) ringing is minimized.

8. A multi-phase switch mode power supply system comprising:
a plurality of circuits, each circuit converting an input voltage to an output voltage; and
a controller configured to:
identify a number of the plurality of circuits;
determine, based on the number of the plurality of circuits and at least one prime number identified based on a phase number associated with each circuit, a timing schedule indicating when each circuit, of the plurality of circuits, is to be activated to deliver the output voltage to a load; and
based on the timing schedule, activate each circuit to deliver the output voltage to the load.

9. The multi-phase switch mode power supply system of claim 8, wherein, when determining the timing schedule, the controller is further configured to determine when each circuit is to be activated using the at least one prime number that is identified based on the phase number associated with each circuit and a summation equation.

10. The multi-phase switch mode power supply system of claim 8, wherein, when determining the timing schedule, the controller is further configured to determine when each circuit is to be activated using a prime number series in which a time of activation of each circuit after a first circuit is calculated based on a previous time of activation of a previous circuit.

11. The multi-phase switch mode power supply system of claim 8, wherein, when determining the timing schedule, the controller is further configured to determine the timing schedule such that that a time between activation of each circuit is approximately equal.

12. The multi-phase switch mode power supply system of claim 8, wherein the controller includes a plurality of controllers on a printed circuit board, each controller of the plurality of controllers having a different clock frequency that is based on a prime number near a common fundamental frequency among clock frequencies of the plurality of controllers.

13. The multi-phase switch mode power supply system of claim 12, wherein each different clock frequency is approximately 100 Hz apart from a clock frequency of another controller of the plurality of controllers.

14. The multi-phase switch mode power supply system of claim 9, wherein, when determining the timing schedule, the controller is further configured to determine the timing schedule such that differential mode ground noise from low side field effect transistor (FET) ringing is minimized.

15. A multi-phase switch mode power supply system comprising:
a first controller that controls a first plurality of phases, wherein the first controller is configured to:
identify a first number of the first plurality of phases,
determine, based on the first number of the first plurality of phases and at least one prime number identified based on a phase number associated with each phase of the first plurality of phases, a first timing schedule indicating when each phase, of the first plurality of phases, is to be activated to convert input voltage to a first output voltage, and
based on the first timing schedule, activate each phase of the first plurality of phases to convert the input voltage to the first output voltage; and
a second controller that controls a second plurality of phases, wherein the second controller is configured to:
identify a second number of the second plurality of phases,
determine, based on the second number of the second plurality of phases and the at least one prime number identified based on a phase number associated with each phase of the second plurality of phases, a second timing schedule indicating when each phase, of the second plurality of phases, is to be activated to convert the input voltage to a second output voltage, and
based on the second timing schedule, activate each phase of the second plurality of phases to convert the input voltage to the second output voltage.

16. The multi-phase switch mode power supply system of claim 15, wherein the first controller and the second controller are parts of a single controller.

17. The multi-phase switch mode power supply system of claim 15, wherein the first controller and the second controller are located on a printed circuit board.

18. The multi-phase switch mode power supply system of claim 16, wherein the first controller has a first clock frequency and the second controller has a second clock frequency that is different from the first clock frequency.

19. The multi-phase switch mode power supply system of claim 18, wherein the first clock frequency and the second clock frequency are determined based on prime numbers.

20. The multi-phase switch mode power supply system of claim 18, wherein the first clock frequency and the second clock frequency are approximately 100 kHz apart.
